(19) United States
(12) Patent Application Publication
(10) Pub. No.: US 2026/0226805 A1
(43) Pub. Date: Aug. 6, 2026

(54) SYSTEMS AND METHODS FOR NON-CONTACT MEASUREMENT FOR CENTRIFUGE SOLIDS DISCHARGE

(71) Applicant: Schlumberger Technology Corporation, Sugar Land, TX (US)

(72) Inventor: Brian Ligertwood, Houston, TX (US)

(21) Appl. No.: 19/042,865

(22) Filed: Jan. 31, 2025

(51) Int. Cl. E21B 21/06; B04B 13/00; E21B 47/10; G06T 7/246; G06T 7/62; H04N 23/90

(52) U.S. Cl. CPC E21B 21/065; B04B 13/00; E21B 47/10; G06T 7/248; G06T 7/62; H04N 23/90; B04B 2013/006; G06T 2207/30181

(57) ABSTRACT

A method for analyzing solids discharged from a drilling process is provided. The method includes detecting a velocity and depth of discharged solids. The method determines a detected flow rate of the discharged solids based on the velocity and the depth of the discharged solids. A system for analyzing discharge from a drilling process, is provided. The system includes a centrifuge system for separating fines from a discharge, an imaging system for providing images of the discharge provided by the centrifuge system, and a processor configured to determine a volume of the discharge based on the images of the discharge.

### BACKGROUND

Wellbores may be drilled into a surface location or seabed for a variety of exploratory or extraction purposes. For example, a wellbore may be drilled to access fluids, such as liquid and gaseous hydrocarbons, stored in subterranean formations and to extract the fluids from the formations. A variety of drilling methods may be utilized depending partly on the characteristics of the formation through which the wellbore is drilled.

For instance, in drilling a well, a drilling fluid (e.g., drilling mud) may be pumped through the downhole tool to aid in the drilling process. The drilling fluid exits the drill bit and is used to lubricate and cool the cutting elements on the drill bit. As the cutting elements degrade the rock formation, rock cuttings are formed. The drilling fluid may also be used to transport the rock cuttings to the surface. At the surface, the slurry (e.g., the combination of drilling fluid, cuttings, and fines) may be provided to a centrifuge system that separates the drilling fluid, the cuttings, and the fines, from each other to be either collected or discharged by the system.

### SUMMARY

In some embodiments, a method of analyzing solids discharge from a drilling process is provided. The method includes detecting a velocity and depth of discharged solids. The method may further include determining a detected flow rate of the discharged solids based on the velocity and the depth of the discharged solids.

In some embodiments, a system for analyzing discharge from a drilling process is provided. The system includes a centrifuge system for separating fines from a discharge. The system further includes an imaging system for providing images of the discharge provided by the centrifuge system. The system further includes a processor configured to determine a volume of the discharge based on the images of the discharge.

In some embodiments, a non-contact camera system for analyzing a discharge from a drilling process is provided. The system includes a first camera having a first view on the discharge, and the first view is oriented vertically perpendicular to a first direction of flow of the discharge. The system further includes a second camera having a second view on the discharge, and the second view is oriented transverse to a second direction of flow of the discharge.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and aspects of embodiments of the disclosure will be set forth in the description which follows, and in part will be obvious from the description, or may be learned by the practice of such embodiments. The features and aspects of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, non-schematic drawings should be considered as being to scale for some embodiments of the present disclosure, but not to scale for other embodiments contemplated herein. Understanding that the drawings depict some example embodiments, the embodiments will be described and explained with additional specificity and detail through the use of the accompanying drawings in which:

FIG. 1 is a side schematic view of a drilling system, according to some embodiments of the present disclosure;

FIG. 2 is an example of a non-contact camera system 200 for analyzing a discharge from a drilling process, according to some embodiments of the present disclosure;

FIGS. 3A and 3B illustrate an example of a top-down view on a first discharge chute at two different periods of time, according to some embodiments of the present disclosure;

FIGS. 4A, 4B, and 4C are examples of a camera view pointed transverse to the flow of discharge, according to some embodiments of the present disclosure; and

FIG. 5 is a flow chart illustrating a method of analyzing solids discharge from a drilling process, according to some embodiments of the present disclosure.

### DETAILED DESCRIPTION

Embodiments of the present disclosure generally relate to devices, systems, and methods for analyzing drill discharge from a centrifuge system. More particularly, some embodiments of the present disclosure relate to the bulk measurements of solids discharge to measure at least one property of the solids. For example, the system may determine a volume and/or a flow rate of the discharged solids to determine how much discharge is produced by the centrifuge system over time. One possible benefit of determining the volume and/or the flow rate of the discharged solids is that the system may predict disposal and/or storage requirements for the discharged solids. For example, one or more predictions of discharged solids may indicate that the system may reach its capacity of disposing and/or storing the discharged solids based on the detected flow rate.

In some embodiments of the present disclosure a density of the discharged solids is determined. One possible benefit of determining the density of the discharged solids is that any abnormalities in the centrifuge system operation may be detected and adjusted or corrected accordingly. For example, when the density of the discharged solids is above a threshold, there may be a higher probability that the discharged solids may clog a discharge chute through which the discharged solids are disposed of and/or stored. In another example, when the density of the discharged solids is below a threshold, it may indicate that the centrifuge system is operating incorrectly and providing too much liquid to the centrifuge system and/or not collecting all fines.

Current systems measure the slurry flow into the centrifuge including both solids, liquids, the collected flow out of the centrifuge system (e.g., density of the fluid collected and flowing out) including fines (e.g., liquids or solids that are desired to be collected), and drilling fluid. Solids that are discharged by the centrifuge system have not been analyzed or monitored.

One possible advantage of analyzing the discharge is to ensure that the centrifuge system is operating properly and with high efficiency, by collecting the fines and drilling fluids before discharging the rest. Another possible advantage is that by providing higher efficiency of the centrifuge system, the discharge disposal costs may be reduced. Furthermore, by providing high efficiency of the centrifuge system, the overall drilling fluid quality may be improved by preventing excessive viscosity.

As illustrated by the foregoing discussion, the present disclosure utilizes a variety of terms to describe features and advantages of the solids discharge measurement system. Additional detail is now provided regarding the meaning of such terms. For example, as used herein, the term “centrifuge system” (or automated centrifuge system) refers to a process for separating substances based on their density by using centrifugal force. The centrifuge system may include a bowl that rotates about a horizontal axis. The bowl may rotate at high speeds, generating a strong centrifugal force. This force causes the denser solid particles to move outward and settle against the inner wall of the bowl. Inside of the bowl there may be a scroll (or conveyor) that rotates at a slightly different speed than the bowl. This allows the scroll to transport the settled solids towards the discharge end of the centrifuge. A slurry may be supplied into the bowl through an inlet of the bowl. As the bowl is rotated, different types of materials in the slurry separate by their different densities. These different types of materials may then be collected (e.g., drilling liquid, or fines), or discharged (solids).

In some embodiments, the centrifuge system may be used to separate solids from liquids. For example, using a low flow rate with the centrifuge at the highest speed, the centrifuge system may discharge the maximum amount of solids. In some embodiments, a high flow rate is used with a low centrifuge speed to collect, for example, drilling fluids. In some embodiments, different flow rates and/or different speeds may be used at different phases of the collection and discharge system. In some embodiments, two or more centrifuge systems may be used to collect and/or discharge substances based on their density. For example, the slurry may be supplied to a first centrifuge system through an inlet and solids may be discharged while the liquid may be collected. The liquid may then be supplied to a second centrifuge system for further processing. For example, to further remove solids (e.g., fines) from the drilling fluid or to separate drilling fluid from liquids (e.g., fines in liquid form) collected from the wellbore before the drilling fluid is returned and/or reused in the drilling process. In one or more embodiments, the drilling fluid and the fluid collected (e.g., fines in liquid form) have a different density so that the centrifuge system can properly separate the two fluids from each other.

As described herein, “fines” are drilling solids (or fluids) that are transported in the drilling fluid out of the drill pipe and into a centrifuge system. The solid fines are particles that are suspended in the fluid. In some examples, the fines have an average or median diameter of up to 80 microns. In some examples, the fines have an average or median major axis of up to 80 microns. In some examples, an average between a major axis and a minor axis of the fines is up to 80 microns. In some embodiments, fines may be smaller than 80 microns. For instance, the diameter, major diameter, or average between the major and minor diameter may be 1 micron, 10 micron, 20 micron, 30 micron, 40 micron, 50 micron, 60 micron, 70 micron, or values therebetween.

In some embodiments, the drilling solids further include cuttings. As described herein, the “cuttings” are particles larger than the fines, and which fall out of suspension in fluid. The cuttings can be between 1 and 3 mm in size. In some examples, the cuttings have an average or median diameter between 1 and 3 mm. In some examples, the average or median major axis of the cuttings is between 1 and 3 mm. In some examples, an average of the major axis and the minor axis of the cuttings is between 1 and 3 mm. In other embodiments, cuttings may be larger than 3 mm. For instance, the diameter, major diameter, or average between the major and minor diameter may be greater than 3 mm (e.g., up to 4 mm, 5 mm, 6 mm, 7 mm, 8 mm, 9 mm, 10 mm, or values therebetween). In some embodiments, the size of fines and cuttings may vary. For instance, depending on the composition of the fines and cuttings, or the properties of the fluid (e.g., composition, viscosity, or density), different sizes of particles may be in suspension or fall out of suspension.

In some embodiments, a “flow rate” refers to a quantity that expresses how much substance (e.g., discharge) passes through a cross-sectional area over a specific time. The amount of discharge is typically quantified using its volume (V) or mass (m).

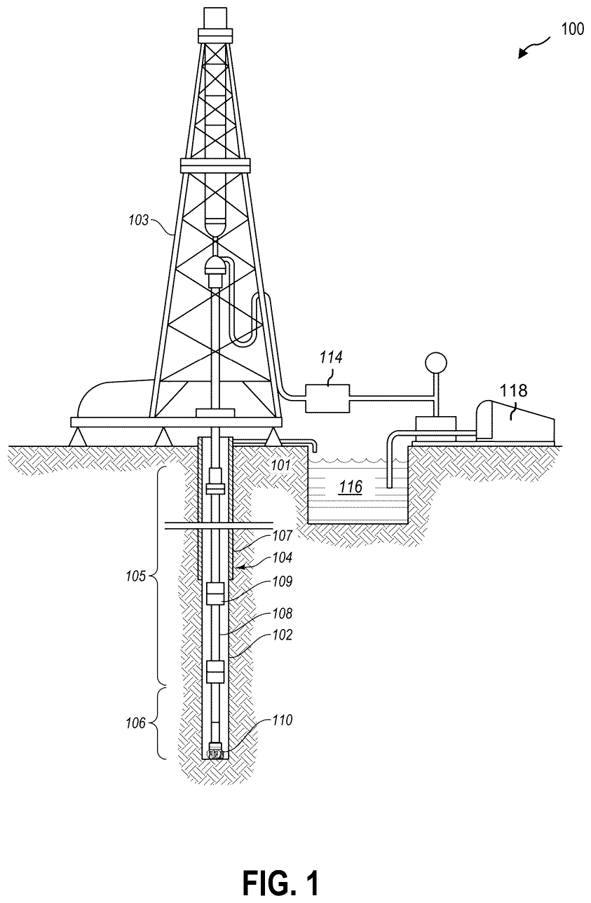

FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of the drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface or may be allowed to fall downhole.

During drilling operations, a drilling fluid (e.g., a drilling mud) may be used to facilitate lubrication and cooling of the bit 110 and removal of cuttings of the earth formation 101. The drilling fluid may be configured to be circulated through the drill string 105, out of the drill string 105 through the bit 110, and into the annulus between the drill string 105 and the surfaces of the earth formation 101 defining the wellbore 102 (or the borehole). For example, a surface pump 114 may pump the drilling fluid from a mud pit 116 which holds the drilling fluid. In some embodiments, one or more additives may be added to the drilling fluid, such as by providing the one or more additives to the mud pit 116.

The drilling fluid may be used to facilitate lubrication and cooling of the bit 110 and removal of cuttings of the earth formation 101 from the borehole 102 and/or wellbore 102. The drilling fluid may include one or more materials formulated and configured to facilitate drilling of the earth formation 101.

The drilling fluid may also be used to transport the rock cuttings to the surface. At the surface, the slurry (e.g., the combination of drilling fluid, cutting formation, and/or fines) may be provided to a centrifuge system 118 that separates the drilling fluid, the cutting formation, and the fines, from each other to be either collected or discharged by the system 100. For example, a drilling fluid collected from the slurry by the centrifuge system 118 may be returned to the mud pit 116 and reused as lubrication and cooling of the bit 110. After the centrifuge system 118 has collected drilling fluid and/or fines from the slurry, the rest of the slurry is discharged by the system.

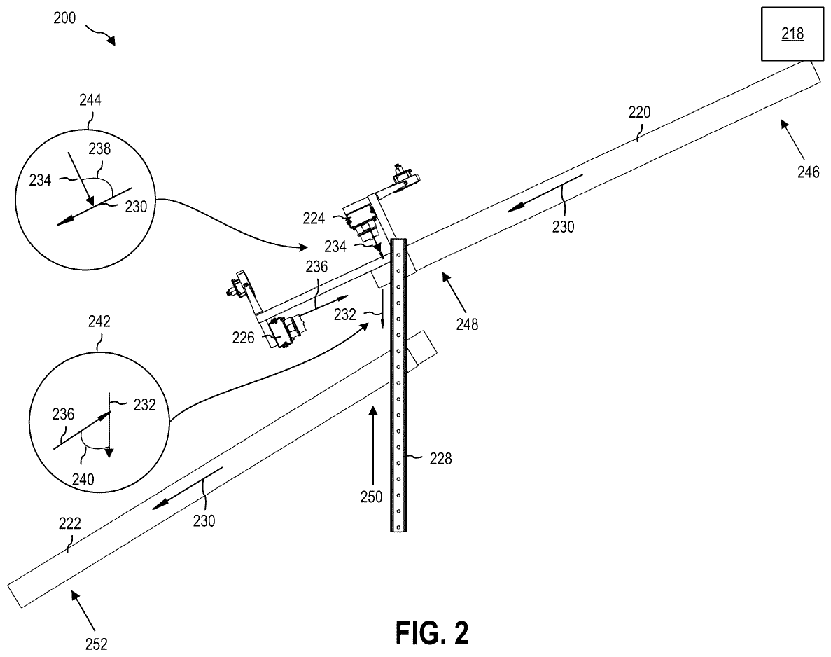

FIG. 2 is an example of a non-contact camera system 200 for analyzing a discharge from a drilling process, according to some embodiments of the present disclosure. In some embodiments, the non-contact camera system 200 includes a first camera 224 located vertically above a first discharge chute 220. In some embodiments, the non-contact camera system 200 includes a first camera 224 having a first view 234 on the discharge, the first view 234 being vertically perpendicular to a first direction of flow 230 of the discharge. For example, the first angle 238 between the first view 234 and the first direction of flow 230 of the discharge may be 90 degrees, as shown by enlargement 244. In some embodiments, the first camera 224 is a still imaging camera configured to capture images at specific time intervals. In some embodiments, the first camera 224 is a video camera configured to capture video images.

In some embodiments, the discharge is disposed to a first discharge chute 220. The first discharge chute 220 may be an inclined channel, such as a trough, tube, or shaft, through which discharge can slide from a higher end of the first discharge chute 246 to a lower end of the first discharge chute 248. The first discharge chute 220 may be connected to a centrifuge system 218 and configured to receive discharge from the centrifuge system 218. In one or more embodiments, the first discharge chute 220 includes one or more of a polyvinyl chloride (PVC), a polytetrafluoroethylene (PTFE), an aluminum, an iron, a titanium, a copper, a manganese, or a carbon.

In some embodiments, the system 200 further includes a second discharge chute 222, the second discharge chute 222 may be an inclined channel, such as a trough, tube, or shaft, through which discharge can slide from a higher end of the second discharge chute 250 to a lower end of the second discharge chute 252. In some embodiments, the second discharge chute 222 is located at least partially under the first discharge chute 220. For example, the lower end of the first discharge chute 248 may partially overlap with the higher end of the second discharge chute 250. In some embodiments, when the discharge reaches the lower end of the first discharge chute 248, the discharge exits the first discharge chute 220 and enters the second discharge chute 222 as shown by a second direction of flow 232 of the discharge. The discharge may then continue to slide from the higher end of the second discharge chute 250 to the lower end of the second discharge chute 252. In some embodiments, the first discharge chute 220 and the second discharge chute 222 are connected by a connector bar 228. For example, the connector bar 228 may be connected to a ground (not shown) and fix the lower end of the first discharge chute 248 to the higher end of the second discharge chute 250 to allow smooth transfer of the discharge from the lower end of the first discharge chute 248 to the higher end of the second discharge chute 250.

In some embodiments, the non-contact camera system 200 includes a second camera 226 located vertically above the second discharge chute 222 and horizontally parallel to the first discharge chute 220. In some embodiments, the non-contact camera system 200 further includes a second camera 226 having a second view 236 on the discharge, the second view 236 being oriented transverse to a second direction of flow 232 of the discharge. For example, a second angle 240 between the second direction of flow 232 and the second view 236 may be less than 90 degrees, as shown by enlargement 242. In some examples, the second angle 240 is 80 degrees. In another example, the second angle 240 is 70 degrees. In yet another example, the second angle 240 is 60 degrees. In some embodiments, the second camera 226 is a still imaging camera configured to capture images at specific time intervals. In some embodiments, the second camera 226 is a video camera configured to capture video images.

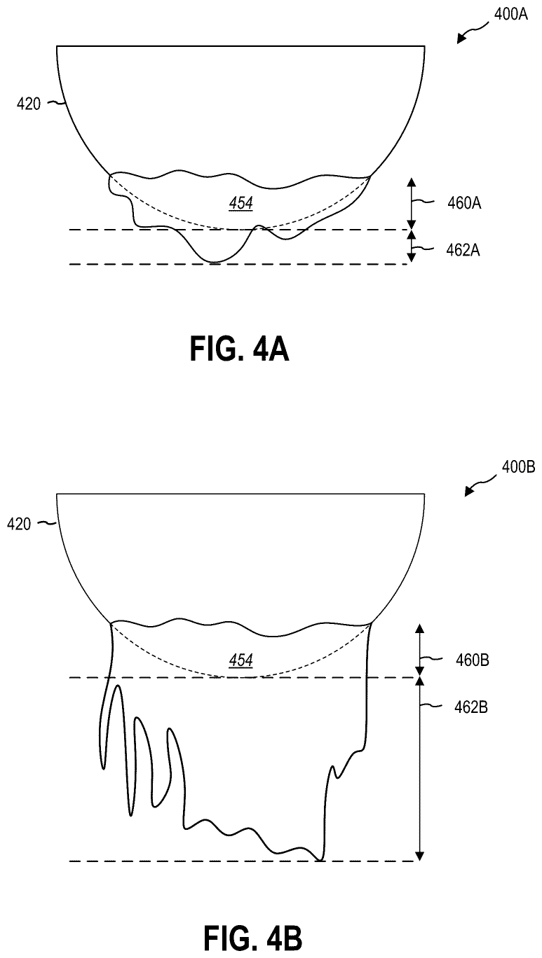

In some embodiments, the first camera 224 is used for detecting a velocity of the discharge and the second camera 226 is used for detecting a volume of the discharge. For example, the velocity may be detected by measuring a speed of movement of the discharge over a period of time. In another example, the volume of the discharge may be detected by measuring the depth of the discharge within a volumetric space carrying the discharge. In some embodiments, the velocity and the volume of the discharge are used for calculating a flow rate of the discharge. For example, the flow rate may be a volumetric flow rate or a mass flow rate. Additional examples of how to calculate a flow rate are further discussed in connection to FIGS. 4A, 4B, and 4C. In some embodiments, the first camera 224 is used for detecting velocity of the discharge and the second camera 226 is used for detecting a mass of the discharge. For example, the mass of the discharge may be detected by detecting a density and volume of the discharge. In some embodiments, both the first camera and the second camera may be used to detect the mass of the discharge.

In some embodiments, the flow rate is compared against a first threshold. For example, the first threshold may be a maximum limit for a flow rate in the system. When the flow rate is higher than the first threshold, a speed of the centrifuge system may be increased. For example, the system may determine that by increasing the speed of the centrifuge more fines may be collected instead of the amount currently collected. In some embodiments, the flow rate is compared against a second threshold. For example, the second threshold may be a minimum limit for a flow rate in the system. When the flow rate is lower than the second threshold, a speed of the centrifuge system may be decreased. For example, the system may determine that by decreasing the speed of the centrifuge more liquid may be discharged instead of the amount currently discharged.

In some embodiments, the flow rate is compared against a first threshold. For example, the first threshold may be a maximum limit for a flow rate in the system. When the flow rate is higher than the first threshold, a speed of a fluid flow to the centrifuge system may be decreased. For example, the system may determine that by decreasing the speed of the fluid flow to the centrifuge system less discharge may be disposed instead of the amount currently discharged. In some embodiments, the flow rate is compared against a second threshold. For example, the second threshold may be a minimum limit for a flow rate in the system. When the flow rate is higher than the second threshold, a speed of the fluid flow to the centrifuge system may be increased. For example, the system may determine that by increasing the speed of the fluid flow to the centrifuge more fines may be collected instead of the amount currently collected, as higher amount of low gravity soils (LGS) may be collected by the centrifuge system.

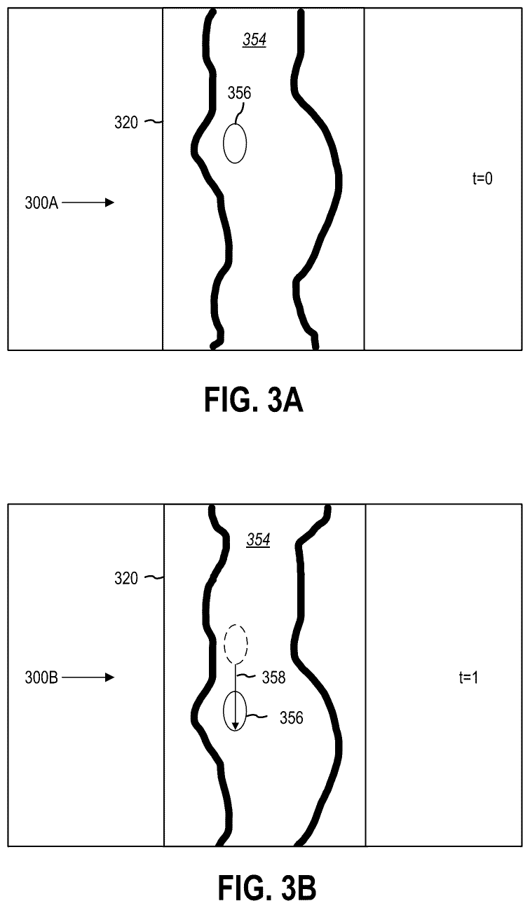

FIG. 3A illustrates an example of a top-down view 300A on a first discharge chute 320 at a first period of time (t=0), and FIG. 3B illustrates an example of the top-down view 300B on the first discharge chute 320 at a second period of time (t=1). In some embodiments, the top-down view 300A and the top-down view 300B is the first view, such as the first view 234 of FIG. 2, provided by a first camera, such as the first camera 224 in FIG. 2. The top-down view 300A and the top-down view 300B show a discharge 354 moving along the first discharge chute 320. In one or more embodiments, the discharge 354 includes one or more distinguishable features 356, such as forms and/or shapes. For example, the one or more distinguishable features 356 may be a higher density substance among the discharge 354, a shape of the discharge 354, a color change on the discharge, or a combination thereof. In the example shown in FIG. 3A, a distinguishable feature 356 is identified at time t=0. In FIG. 3B, the distinguishable feature 356 is identified at time t=1. The location of the distinguishable feature 356 at t=1 has moved a distance 358 from the location it was at t=0, as shown in FIG. 3B. In one or more embodiments, the system calculates a velocity of the movement with the distance 358 and time information. For example, if the distance 358 is ten centimeters (cm) and the time difference between 3A and 3B is one second, the velocity is distance/time difference, 3.6 meters per hour (m/h). In one or more embodiments, two or more distinguishable features may be used to detect distance 358. For example, if two or more distinguishable features are detected and the detected distance of movement for the two or more distinguishable features differ from one another, an average distance may be calculated among the two or more distinguishable features. The average distance of movement may then be used to calculate the velocity of movement of the discharge 354.

In some embodiments, the first camera is used for determining a pattern of movement of the discharged solids. For example, a pattern of the movement of the discharged solids may be determined based on detecting a first location of a discharged solid with one or more distinguishable features on a first image, and a second location of the discharged solid with the one or more distinguishable features on the second image and comparing the first location to the second location.

FIGS. 4A, 4B, and 4C illustrate three examples of a side view (400A, 400B, and 400C) on a first discharge chute 420, according to some embodiments of the present disclosure. The first discharge chute 420 may be an inclined channel, such as a trough, tube, or shaft, through which discharge can slide from a higher end of the first discharge chute to a lower end of the first discharge chute.

In some embodiments, the side view 400A, 400B and 400C are the second view, such as the second view 236 of FIG. 2, provided by a second camera, such as the second camera 226 in FIG. 2. The side view 400A, 400B, and 400C show a discharge 454 moving along the first discharge chute 420 and dropping from the first discharge chute 420 towards a second discharge chute (not shown) located at least partially under the first discharge chute 420, as shown in connection with FIG. 2.

As shown in FIG. 4A, in some embodiments, the side view 400A shows the discharge 454 having a discharge depth 460A inside of the first discharge chute 420, and a runoff having a runoff depth 462A. The runoff represents the discharge 454 dropping off the first discharge chute 420. In some embodiments, the discharge depth 460A is used for calculating a volume of the discharge. For example, the volume (V) may be calculated using a horizontal cylinder segment for the discharge chute as provided below:

$$V = L ( {R}^{2} {cos}^{- 1} ( \frac{R - D}{R} ) - ( R - D ) \sqrt{2 R D - {D}^{2}} )$$

wherein L is the length of the cylinder, R is the radius of the cylinder, and D is the depth of discharge in the cylinder (e.g., 460A, 460B, and 460C). In some embodiments, the discharge chute is not a closed cylinder, but a half-a-cylinder, or more or less than a half-a-cylinder. In these situations, the radius R represents an approximation of a full-cylinder. In some embodiments, the discharge chute may be a flat channel, in which case the volume (V) may be calculated using a cross-sectional area of the chute as provided below:

$$V = A v$$

wherein A is the cross-sectional area (width×height) of the chute and v is the velocity of the discharge.

In some embodiments, a flow rate of the discharge may be determined. For example, a flow rate may be a volumetric flow rate or a mass flow rate. In some embodiments, the volumetric flow rate may be defined as the volume of a given discharge that passes through a given cross-sectional area per unit of time. For example, the volumetric flow rate (Q) may be calculated as provided below:

$$Q = \frac{V}{t}$$

wherein V is the volume and t is the unit of time.

In some embodiments, a mass flow rate may be calculated by analyzing the discharge density using the runoff depth (e.g., 462A, 462B, or 462C). In some embodiments, the density of the discharge may be calculated by utilizing the knowledge of mass of the discharge. The mass flow rate (MFR) may be calculated as provided below:

$$MFR = ρ Q$$

wherein ρ is the density of the discharge and Q is the volumetric flow rate. The density of the discharge (ρ) may be calculated as

$$ρ = \frac{m}{V} ,$$

wherein m is the mass of the discharge and V is the volume of the discharge.

In some embodiments, the MFR may be calculated by using the mass of the discharge as provided below:

$$MFR = \frac{m}{t}$$

wherein m is the mass of discharge and t is time in which the mass passes through the system. For example, in some embodiments, the system measures the intake material (e.g., slurry) provided to the centrifuge, the inlet and outlet of fluids, and also the fines collected from the centrifuge process. The remaining material is the discharge, and the mass of the discharge is the difference between the mass of the slurry and the mass of the fines collected. The inlet and outlet density may also be used to estimate the mass of the discharge.

In FIG. 4A the discharge depth 460A is relatively low, while the runoff depth 462A is relatively low as well. A relatively low discharge depth 460A indicates that there is lower risk of overflowing the discharge system over time. If the flow rate calculated using the velocity of the discharge is relatively low as well, it indicates even lower risk of overflowing the discharge system. A relatively low runoff depth 462A may indicate that the density of the discharge is higher, but not too high if the discharge depth 460A stays low as well. Overall, the centrifuge system in FIG. 4A seems to be working properly, by providing solid discharge flow at a reasonable flow rate.

In FIG. 4B the discharge depth 460B is relatively low, while the runoff depth 462B is relatively high. A relatively low discharge depth 460B indicates that there is lower risk of overflowing the discharge system over time. A relatively high runoff depth 462B, however, may indicate that the flow rate is relatively high while the density of the discharge is lower. This may indicate that the centrifuge system is working incorrectly, by either not collecting all fines, or by providing too much liquid to the centrifuge process.

In FIG. 4C the discharge depth 460C is relatively high, while the runoff depth 462C is relatively low. In some embodiments, a relatively high discharge depth 460C indicates that there is a risk of overflowing the discharge system over time. In some embodiments, a relatively low runoff depth 462C, may indicate that the density of the discharge is high. In some embodiments, where the discharge depth 460C is high, the runoff depth 462C is low, and a velocity is low, it may indicate that there is a high risk of clogging the discharge system over time as the discharged solids are not moving fast enough to clear the discharge chute. As a remedy, more fluid may be provided to the centrifuge system, or the speed of the centrifuge may be slowed down. In general, a high discharge depth may be desired, as it indicates that a bigger amount of low gravity solids (LGS) are removed by the centrifuge system.

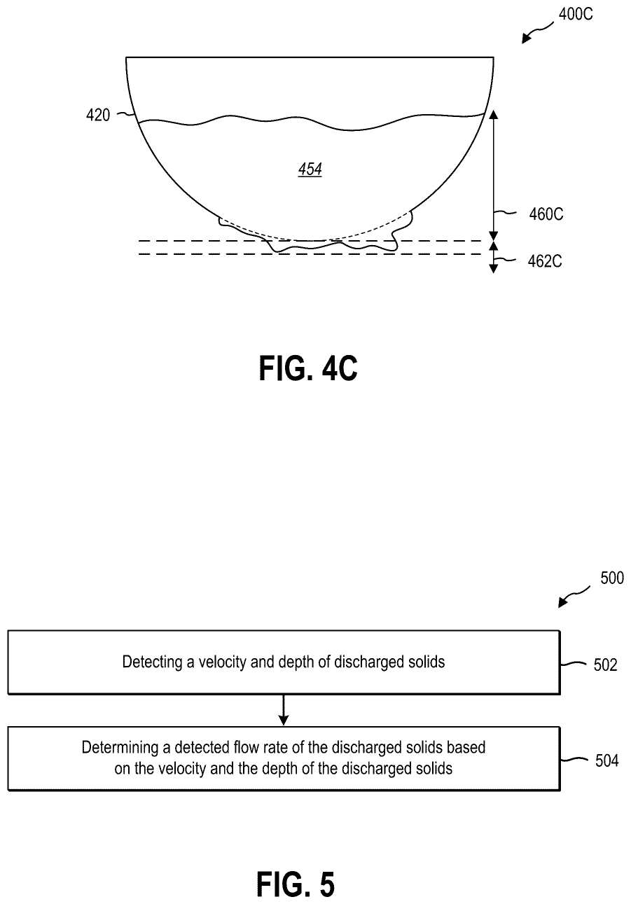

FIG. 5 is a flowchart illustrating a method 500 of analyzing solids discharge from a drilling process. The method 500 includes an act 502 of detecting a velocity and depth of a discharged solids. For example, detecting the velocity and the depth of the discharge of the discharged solids is performed with an imaging system. In some embodiments, the imaging system includes a camera configured to take a first image at a first time and a second image at a second time after the first time. In some embodiments, the camera is a first camera having a first view on the discharged solids, wherein the first view is vertically perpendicular to a first direction of flow of the discharged solids. In some embodiments, the imaging system further includes a second camera having a second view on the discharged solids, wherein the second view is oriented transverse to a second direction of flow of the discharged solids. In some embodiments, the first camera is used for detecting the velocity of the discharged solids and the second camera is used for detecting the depth of the discharged solids. For example, the second time may be less than 1 second after the first time, between one and two seconds, or less than one second after the first time. In some embodiments, the first camera and the second camera are still imaging cameras configured to capture images at specific time intervals. In some embodiments, the first camera and the second camera are a video camera configured to capture video images.

The method further includes an act 504 of determining a detected flow rate of the discharged solids based on the velocity and the depth of the discharged solids. For example, the detected flow rate may be a volumetric flow rate or a mass flow rate. In some embodiments, the detected flow rate of the discharged solids is used for determining one or more of efficiency of a centrifuge system, or that the centrifuge is operating incorrectly.

This application relates to analyzing discharge from a drilling process according to the present disclosure. For example, embodiments of this application may be described according to any of the following sections:
A1. A method of analyzing solids discharged from a drilling process, comprising:
   detecting a velocity and depth of discharged solids; and
   determining a detected flow rate of the discharged solids based on the velocity and the depth of the discharged solids.
A2. The method of section A1, further including determining a composition of the discharged solids.
A3. The method of section A2, wherein determining the composition of the discharged solids further includes comparing an intake to collected fines, wherein the composition of the discharged solids corresponds to a difference of the collected fines from the intake.
A4. The method of any of the sections A1-A2, wherein detecting the velocity and the depth of the discharged solids is performed with an imaging system.
A5. The method of section A4, wherein the imaging system includes a camera configured to take a first image at a first time and a second image at a second time after the first time.
A6. The method of section A5, wherein the camera is a first camera having a first view on the discharged solids, wherein the first view is vertically perpendicular to a first direction of flow of the discharged solids.
A7. The method of section A6, wherein the imaging system further includes a second camera having a second view on the discharged solids, wherein the second view is oriented transverse to a second direction of flow of the discharged solids.
A8. The method of section A7, wherein the first camera is used for detecting the velocity of the discharged solids and the second camera is used for detecting the depth of the discharged solids.
A9. The method of any of the sections A5-A8, wherein the second time is less than one second after the first time.
A10. The method of any of the sections A5-A8, wherein the second time is between one and two seconds after the first time.
A11. The method of any of the sections A5-A8, further including determining a pattern of movement of the discharged solids.
A12. The method of section A11, wherein the pattern of the movement of the discharged solids is determined based on detecting a first location of a discharged solid with one or more distinguishable features on the first image, and a second location of the discharged solid with the one or more distinguishable features on the second image and comparing the first location to the second location.
A13. The method of any of the sections A1-A12, wherein a volume of the discharged solids is calculated based on the depth of the discharged solids.
A14. The method of section A13, wherein the volume and the velocity of the discharged solids are used for determining a volumetric flow rate of the discharged solids.
A15. The method of any of the section A1-A14, wherein the detected flow rate of the discharged solids is used for determining efficiency of a centrifuge system.
A16. The method of any of the sections A1-A15, wherein the detected flow rate of the discharged solids is used for determining that a centrifuge is operating incorrectly.
A17. The method of any of the sections A1-A16, wherein the detected flow rate is a mass flow rate and wherein a mass of the discharged solids is determined based on a density and volume of the discharged solids.
B1. A system for analyzing discharge from a drilling process, comprising:
   a centrifuge system for separating fines from a discharge;
   an imaging system for providing images of the discharge provided by the centrifuge system; and
   a processor configured to determine a volume of the discharge based on the images of the discharge.
B2. The system of section B1, wherein the system further includes a first discharge chute connected to the centrifuge system and configured to receive the discharge from the centrifuge system.
B3. The system of section B2, further including a second discharge chute, wherein the second discharge chute is located at least partially under the first discharge chute.
B4. The system of section B3, wherein the first discharge chute includes a higher first discharge chute end and a lower first discharge chute end, the second discharge chute includes a higher second discharge chute end and a lower second discharge chute end, and wherein the higher second discharge chute end is located at least partially under the lower first discharge chute end.
B5. The system of any of the sections B2-B4, wherein the first discharge chute includes one or more of a polyvinyl chloride (PCV), a polytetrafluoroethylene (PTFE), an aluminum, an iron, a titanium, a copper, a manganese, or a carbon.
B6. The system of any of the sections B3-B5, wherein the imaging system includes a first camera located vertically above the first discharge chute, and a second camera located vertically above the second discharge chute and horizontally parallel to the first discharge chute.
B7. The system of section B6, wherein the first camera is configured to have a first view on the discharge, wherein the first view is vertically perpendicular to a first direction of flow of the discharge.
B8. The system of section B7, wherein the second camera is configured to have a second view on the discharge, wherein the second view is oriented transverse to a second direction of flow of the discharge.
C1. A non-contact camera system for analyzing a discharge from a drilling process, comprising:
   a first camera having a first view on the discharge, wherein the first view is oriented vertically perpendicular to a first direction of flow of the discharge; and
   a second camera having a second view on the discharge, wherein the second view is oriented transverse to a second direction of flow of the discharge.
C2. The non-contact camera system of section C1, wherein the first camera is used for detecting velocity of the discharge and the second camera is used for detecting volume of the discharge.
C3. The non-contact camera system of section C2, wherein the velocity is detected by detecting a first location of the discharge with one or more distinguishable features on a first image, and a second location of the discharge with the one or more distinguishable features on a second image, and comparing the first location to the second location.
C4. The non-contact camera system of any of the sections C2-C3, wherein the volume is detected by measuring a depth of the discharge.
C5. The non-contact camera system of any of the sections C2-C4, wherein the velocity and the volume of the discharge are used for calculating a flow rate of the discharge.
C6. The non-contact camera system of section C5, wherein the flow rate is compared against a first threshold, and wherein a speed of a centrifuge system is increased when the flow rate is higher than the first threshold.
C7. The non-contact camera system of section C6, wherein the flow rate is compared against a second threshold, and wherein the speed of the centrifuge system is decreased when the flow rate is lower than the second threshold.
C8. The non-contact camera system of any of the sections C5-C6, wherein the flow rate is compared against a first threshold, and wherein a speed of a fluid flow to a centrifuge system is decreased when the flow rate is higher than the first threshold.
C9. The non-contact camera system of section C8, wherein the flow rate is compared against a second threshold, and wherein the speed of the fluid flow to the centrifuge system is increased when the flow rate is lower than the second threshold.
C10. The non-contact camera system of any of the sections C5-C9, wherein the flow rate is volumetric flow rate.
C11. The non-contact camera system of any of the sections C5-C10, wherein the flow rate is mass flow rate.

One or more specific embodiments of the present disclosure are described herein. These described embodiments are examples of the presently disclosed techniques. Additionally, in an effort to provide a concise description of these embodiments, not all features of an actual embodiment may be described in the specification.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein, to the extent such features are not described as being mutually exclusive. Numbers, percentages, ratios, or other values stated herein are intended to include that value, and also other values that are “about”, “substantially”, or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. The described embodiments are therefore to be considered as illustrative and not restrictive, and the scope of the disclosure is indicated by the appended claims rather than by the foregoing description.

1. A method of analyzing solids discharged from a drilling process, comprising:
detecting a velocity and depth of discharged solids; and
determining a detected flow rate of the discharged solids based on the velocity and the depth of the discharged solids.

2. The method of claim 1, further including determining a composition of the discharged solids.

3. The method of claim 2, wherein determining the composition of the discharged solids further includes comparing an intake material to collected fines, wherein the composition of the discharged solids corresponds to a difference between a composition of the intake material and a composition of the collected fines.

4. The method of claim 1, wherein detecting one or more of the velocity or the depth of the discharged solids is performed with an imaging system.

5. The method of claim 4, wherein the imaging system includes a camera configured to take a first image at a first time and a second image at a second time after the first time.

6. The method of claim 5, wherein the camera is a first camera having a first view on the discharged solids, wherein the first view is vertically perpendicular to a first direction of flow of the discharged solids.

7. The method of claim 6, wherein the imaging system further includes a second camera having a second view on the discharged solids, wherein the second view is oriented transverse to a second direction of flow of the discharged solids.

8. The method of claim 7, wherein the first camera is used for detecting the velocity of the discharged solids and the second camera is used for detecting the depth of the discharged solids.

9. The method of claim 5, wherein the second time is less than one second after the first time.

10. The method of claim 5, wherein the second time is between one and two seconds after the first time.

11. The method of claim 1, wherein a volume of the discharged solids is calculated based on the depth of the discharged solids.

12. The method of claim 11, wherein the volume and the velocity of the discharged solids are used for determining a volumetric flow rate of the discharged solids.

13. The method of claim 1, wherein the detected flow rate is a mass flow rate and wherein a mass of the discharged solids is determined based on a density and volume of the discharged solids.

14. A system for analyzing discharge from a drilling process, comprising:
a centrifuge system for separating fines from a discharge;
an imaging system for providing images of the discharge provided by the centrifuge system; and
a processor configured to determine a volume of the discharge based on the images of the discharge.

15. The system of claim 14, wherein the system further includes a first discharge chute connected to the centrifuge system and configured to receive the discharge from the centrifuge system.

16. The system of claim 15, further including a second discharge chute, wherein the second discharge chute is located at least partially under the first discharge chute.

17. The system of claim 16, wherein the imaging system includes a first camera located vertically above the first discharge chute, and a second camera located vertically above the second discharge chute and horizontally parallel to the first discharge chute.

18. A non-contact camera system for analyzing discharge from a drilling process, comprising:
a first camera having a first view on the discharge, wherein the first view is oriented vertically perpendicular to a first direction of flow of the discharge; and
a second camera having a second view on the discharge, wherein the second view is oriented transverse to a second direction of flow of the discharge.

19. The non-contact camera system of claim 18, wherein the first camera is used for detecting velocity of the discharge and the second camera is used for detecting volume of the discharge.

20. The non-contact camera system of claim 19, wherein the velocity is detected by detecting a first location of the discharge with one or more distinguishable features on a first image, detecting a second location of the discharge with the one or more distinguishable features on a second image, and comparing the first location to the second location.
